(19) United States
(12) Patent Application Publication
(10) Pub. No.: US 2010/0182254 A1
(43) Pub. Date: Jul. 22, 2010

(54) TOUCH SCREEN PANEL

(76) Inventors: Choon-Hyop Lee, Yongin-city (KR); Jung-Mok Park, Yongin-city (KR); Sung-Ku Kang, Yongin-city (KR); Hwan-Hee Jeong, Yongin-city (KR); Tae-Hyeog Jung, Yongin-city (KR); Shawn Kim, Yongin-city (KR); Sang-Kook Kim, Yongin-city (KR)

Correspondence Address: CHRISTIE, PARKER & HALE, LLP, PO BOX 7068, PASADENA, CA, 91109-7068, US

(21) Appl. No.: 12/566,631

(22) Filed: Sep. 24, 2009

(30) Foreign Application Priority Data
Jan. 16, 2009 (KR) 10-2009-0003643

(51) Int. Cl. G06F 3/041

(52) U.S. Cl. 345/173

(57) ABSTRACT

A touch screen panel includes a substrate having high transmittance, sensing patterns on a first surface of the substrate, a film on the sensing patterns, and metal patterns and position detecting lines on the film and electrically coupled to the sensing patterns, wherein a second surface of the substrate opposite the first surface is adapted to be contacted by a contact object.

### CROSS-REFERENCE TO RELATED APPLICATION

This application claims priority to and the benefit of Korean Patent Application No. 10-2009-0003643, filed on Jan. 16, 2009, in the Korean Intellectual Property Office, the entire content of which is incorporated herein by reference.

### BACKGROUND OF THE INVENTION

1. Field of the Invention

Embodiments of the present invention relates to a touch screen panel.

2. Description of the Related Art

A touch screen panel is an input device capable of inputting a user's instructions by allowing the user to select content displayed on a screen of an image display device using the user's finger or a similar object.

To this end, the touch screen panel is provided on a front face of a flat panel display device to convert information of a contact position that directly contacts the user's finger or similar object into an electrical signal. Therefore, the content selected at the contact position is received as an input signal. A window is commonly attached to the front face of the touch screen panel to improve durability and to protect the touch screen panel.

Since touch screen panels can replace an additional input device, such as a keyboard and/or a mouse, application of touch screen panels is widely expanding.

When the touch screen panel is attached to the panel of an image display device, a size of the image display device increases, and ease of portability may be reduced.

Furthermore, as described above, the window is commonly attached to the touch screen panel to protect the touch screen panel, which makes the touch screen panel thicker.

### SUMMARY OF THE INVENTION

Accordingly, exemplary embodiments of the present invention provide a touch screen panel including a glass substrate used as a window, in which sensing patterns including fine patterns are on one surface of the glass substrate and a film is on the sensing patterns, the film having corresponding wiring lines that may not include fine patterns, thereby simplifying manufacturing processes and making the touch screen panel thinner.

According to an exemplary embodiment of the present invention, there is provided a touch screen panel including a substrate having high transmittance, sensing patterns on a first surface of the substrate, a film on the sensing patterns, and metal patterns and position detecting lines on the film and electrically coupled to the sensing patterns, wherein a second surface of the substrate opposite the first surface is adapted to be contacted by a contact object.

The touch screen panel may further include an insulating layer between the sensing patterns and the film, and a first adhesive layer between the insulating layer and the film, and may also further include a second adhesive layer on the film and a ground electrode layer on the second adhesive layer.

The film may include polyethylene terephthalate (PET).

The sensing patterns may include first sensing patterns and second sensing patterns on different layers. The first sensing patterns may be coupled to each other in a first direction, and the second sensing patterns may be coupled to each other in a second direction that crosses the first direction.

The metal patterns may be arranged corresponding to edge regions of the sensing patterns, and may be arranged such that the sensing patterns are electrically coupled to corresponding ones of the position detecting lines in the first direction or the second direction.

As described above, according to exemplary embodiments of the present invention, the glass substrate of the touch screen panel is utilized as the window, whereby the glass substrate is adapted to be contacted by a contact object. The sensing patterns including fine patterns are on one surface of the glass substrate, and the film is on the sensing patterns, the film including the corresponding wiring lines that do not include fine patterns, thereby simplifying manufacturing processes and making the touch screen panel thinner.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view schematically illustrating a touch screen panel according to an embodiment of the present invention; and

FIG. 2 is a schematic cross-sectional view illustrating a main portion of the touch screen panel according to the embodiment of FIG. 1.

### DETAILED DESCRIPTION

In the following detailed description, only certain exemplary embodiments of the present invention have been shown and described by way of illustration. As those skilled in the art will recognize, the described embodiments may be modified in various different ways without departing from the spirit or scope of the present invention. Accordingly, the drawings and description are to be regarded as illustrative in nature and not restrictive. In addition, when an element is referred to as being “on” another element, it may be directly on another element, or may be indirectly on another element, with one or more intervening elements interposed therebetween. Also, when an element is referred to as being “coupled to” another element, it can be directly coupled to another element, or may be indirectly coupled to another element, with one or more intervening elements coupled therebetween. Hereinafter, like reference numerals refer to like elements.

Embodiments of the present invention will be described in detail with reference to the accompanying drawings.

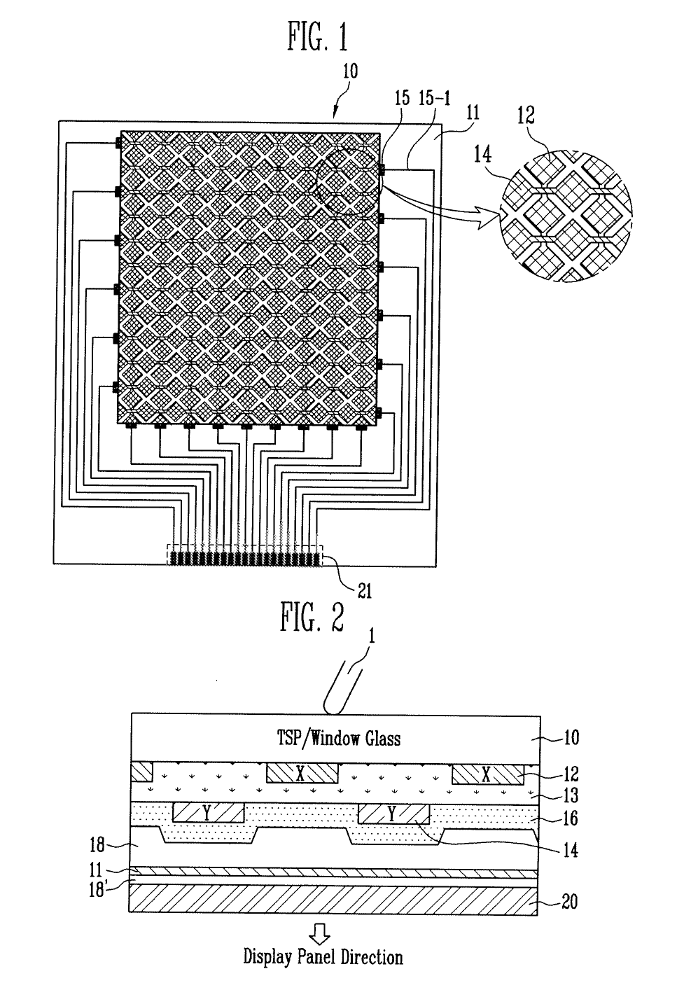

FIG. 1 is a plan view schematically illustrating a touch screen panel according to an embodiment of the present invention.

Referring to FIG. 1, the touch screen panel according to embodiments of the present invention includes a plurality of sensing patterns 12 and 14 formed on one surface of a glass substrate 10 utilized as a window, metal patterns 15 and position detecting lines 15-1 formed (e.g., in advance) on a film 11 attached to one surface of the glass substrate 10 and electrically coupled to the sensing patterns. In some embodiments, materials other than glass, for example, transparent materials or materials with high transmittance, may be utilized for the substrate 10.

Here, in embodiments of the present invention, elements that include fine patterns, which are more difficult to assemble, e.g., the sensing patterns 12 and 14, are formed on the glass substrate through exposing and developing processes, whereas elements that do not include fine patterns, e.g., the detecting lines 15-1 and the metal patterns 15, are formed by attaching the film 11 on which the detecting lines and the metal patterns are formed (e.g., pre-formed in advance), thereby simplifying manufacturing processes and making the touch screen panel thinner.

The sensing patterns 12 and 14 include X sensing patterns 12 and Y sensing patterns 14 which are arranged to cross each other, with X sensing patterns 12 having a same X coordinate (e.g., arranged in a same column) being coupled to each other by column, and with Y sensing patterns 14 having a same Y coordinate (e.g., arranged in a same row) being coupled to each other by row.

For example, the X sensing patterns 12 include a plurality of X patterns formed so that sensing patterns having the same X coordinate in one column are coupled to each other in a first direction (e.g., the column direction). The Y sensing patterns 14 include a plurality of Y patterns formed so that sensing patterns having the same Y coordinate in one row are coupled to each other in a second direction (e.g., the row direction).

The X and Y sensing patterns 12 and 14 can be formed on different layers with an additional insulating layer interposed therebetween.

In this case, in a patterning process, the X sensing patterns 12 are patterned to be coupled to each other in a first direction and the Y sensing patterns 14 are patterned to be coupled to each other in a second direction. Therefore, additional processes of forming contact holes and coupling patterns can be omitted, so that fewer masks are used and the manufacturing process is simplified.

However, it should be noted that the aforementioned process is only an illustrative embodiment of the present invention, but the present invention is not limited thereto.

For example, the X and Y sensing patterns 12 and 14 may be formed on a same layer, such as the glass substrate 10. In this case, one of the X and Y sensing patterns 12 and 14 are formed to be coupled to each other in one of the first or second directions in the patterning process, and the other one of the X and Y sensing patterns 12 and 14 are formed to be coupled to each other in the other one of the first or second directions in the processes of forming the contact holes and the coupling patterns.

Since the sensing patterns 12 and 14 include fine patterns and are more difficult to assemble as described above, the sensing patterns 12 and 14 are formed on the glass substrate through exposing and developing processes in some embodiments.

The metal patterns 15 are arranged at edge regions of the X and Y sensing patterns 12 and 14 to couple the X and Y sensing patterns 12 and 14 to the position detecting lines 15-1.

According to an embodiment of the present invention, the metal patterns 15 and/or the position detecting lines 15-1 are formed in advance on the film 11, e.g., a polyethylene terephthalate (PET) film, and then the PET film 11 is attached to the glass substrate.

That is, according to an embodiment of the present invention, since the metal patterns 15 and/or the position detecting lines 15-1 do not include fine patterns, unlike the above-described sensing patterns 12 and 14, the metal patterns and/or the position detecting lines 15-1 may be formed on the film 11 in advance, and then the film 11 is attached onto the glass substrate 10. Therefore, in manufacturing the touch screen panel, manufacturing processes can be simplified and the touch screen panel can be made thinner.

To be more specific, the metal patterns 15 electrically couple the X and Y sensing patterns 12 and 14 by column or row to the position detecting lines 15-1 for determining a contact position detecting signal to be supplied to a driving circuit.

For example, the metal patterns 15 electrically couple first sensing patterns 12 in one column to a corresponding one of the position detecting lines 15-1 and electrically couple second sensing patterns 14 in one row to another corresponding one of the position detecting lines 15-1. Accordingly, the position detecting lines 15-1 are respectively coupled to the first and second sensing patterns 12 and 14 through the metal patterns 15 to couple the first and second sensing patterns 12 and 14 to a driving circuit.

That is, when the touch screen panel 10 is coupled to an external driving circuit through a pad unit 21, the position detecting lines 15-1 can be coupled between the pad unit 21 and the sensing patterns 12 and 14.

Furthermore, since the metal patterns 15 and the position detecting lines 15-1 are formed in advance on the film 11, the metal patterns 15 and the position detecting lines 15-1 are preferably made of a same material in a same process.

When a contact object, such as a user's finger or a touch stick, contacts a touch screen panel which is an electrostatic capacitance type touch screen panel, a change in electrostatic capacitance in accordance with a contact position is transmitted from the sensing patterns 12 and 14 to the driving circuit via the metal patterns 15 and the position detecting lines 15-1. The change in the electrostatic capacitance is converted into an electric signal by X and Y input processing circuit (not shown) so that the contact position can be detected.

According to an embodiment of the present invention, the sensing patterns 12 and 14 are arranged in a plane parallel to a display panel (not shown). That is, in embodiments where the display panel is positioned under the touch screen panel, and where the contact surface is arranged at an upper surface of the touch screen panel, the sensing patterns 12 and 14 are formed under a glass substrate 10. The upper surface of the glass substrate 10 functions as both the contact surface that a contact object contacts and as the window of the display device.

That is, according to an embodiment of the present invention, an additional window is not provided, since the glass substrate of the touch screen panel is integrated with the window. In other words, the glass substrate is adapted to be contacted by contact objects. Therefore, the touch screen panel is thinner, manufacturing efficiency can be improved as manufacturing processes are simplified, and cost of materials can be reduced.

FIG. 2 is a schematic cross-sectional view illustrating a main portion of the touch screen panel according to the embodiment of FIG. 1.

Referring to FIG. 2, the touch screen panel according to the embodiment of FIG. 1 includes sensing patterns 12 and 14, a second insulating layer 16, a first adhesive layer 18, a film 11 on which metal patterns (not shown) and position detecting lines are formed, a second adhesive layer 18′, and a ground electrode layer 20 which are sequentially formed on one surface of a glass substrate 10.

Here, the sensing patterns 12 and 14 are formed on one surface of the glass substrate 10, for example, a lower surface of the glass substrate 10 facing the display panel. The metal patterns 15 of FIG. 1 arranged at edge regions of the sensing patterns 12 and 14 and the position detecting lines 15-1 of FIG. 1 coupled to the metal patterns are attached to the glass substrate via the first adhesive layer 18, the metal patterns 15 and the position detecting lines 15-1 formed in advance on the film 11 (for example, the PET film).

In addition, the other surface of the glass substrate 10 faces a direction from which a contact object 1 comes into contact. That is, the glass substrate 10 is integrated with the window.

In FIG. 2, the metal patterns positioned at the edge regions of the touch screen panel and the position detecting lines are not illustrated, but are generally arranged similarly as in FIG. 1.

The sensing patterns 12 and 14 are alternately arranged on different layers, with a first insulating layer 13 made of a transparent material interposed therebetween. However, the present invention is not limited thereto, for example, the sensing patterns 12 and 14 may be arranged on the same layer.

The sensing patterns 12 and 14 are made of a transparent electrode material such as indium tin oxide (ITO), so that light emitted from the display panel positioned under the touch screen panel can transmit through the touch screen panel.

The sensing patterns 12 and 14 are covered with the second insulting layer 16 made of a transparent material.

The first adhesive layer 18 is formed between the second insulating layer 16 and the film 11 on which the metal patterns and the position detecting lines are formed to adhere the second insulating layer 16 to the film 11. In addition, the second adhesive layer 18′ is formed between the film 11 and the ground electrode layer 20 to adhere the film 11 to the ground electrode layer 20.

The first and second adhesive layers 18 and 18′ are made of a transparent adhesive material having high transmittance such as super view resin (SVR) and/or optical cleared adhesive (OCA).

The ground electrode layer 20 is made of a transparent electrode material such as ITO. The ground electrode layer 20 can be utilized for maintaining stability between the touch screen panel and the display panel, and can also be used for forming electrostatic capacitances with the sensing patterns 12 and 14 depending on a designing method of the touch screen panel.

That is, in an electrostatic capacitance type touch screen panel, electrostatic capacitances between the X and Y sensing patterns 12 and 14 and the ground electrode layer 20 can be utilized to sense a contact position.

On the other hand, the ground electrode layer 20 may not be provided in the touch screen panel, but may instead be provided on the surface of the display panel coupled to the touch screen panel.

According to the embodiment of the present invention having the above-described structure, the glass substrate 10 of the touch screen panel and the window are integrated with each other, whereby contact objects come into contact with the glass substrate 10. As indicated previously, in some embodiments, the substrate 10 may be comprised of materials other than glass, for example, transparent materials or materials with high transmittance.

In addition, the elements that include fine patterns and involve more complicated assembly, e.g., the sensing patterns 12 and 14, are formed on the glass substrate through the exposing and developing processes, whereas elements that do not include fine patterns, e.g., the position detecting lines 15-1 and the metal patterns 15, are formed by attaching the film 11 on which position detecting lines and metal patterns are formed in advance, thereby simplifying manufacturing processes and making the touch screen panel thinner.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A touch screen panel, comprising:
a substrate having high transmittance;
sensing patterns on a first surface of the substrate;
a film on the sensing patterns; and
metal patterns and position detecting lines on the film and electrically coupled to the sensing patterns,
wherein a second surface of the substrate opposite the first surface is adapted to be contacted by a contact object.

2. The touch screen panel as claimed in claim 1, further comprising:
an insulating layer between the sensing patterns and the film; and
a first adhesive layer between the insulating layer and the film.

3. The touch screen panel as claimed in claim 2, further comprising:
a second adhesive layer on the film; and
a ground electrode layer on the second adhesive layer.

4. The touch screen panel as claimed in claim 1, wherein the film comprises polyethylene terephthalate (PET).

5. The touch screen panel as claimed in claim 1, wherein the sensing patterns comprise first sensing patterns and second sensing patterns on different layers.

6. The touch screen panel as claimed in claim 5,
wherein the first sensing patterns are coupled to each other in a first direction, and
wherein the second sensing patterns are coupled to each other in a second direction that crosses the first direction.

7. The touch screen panel as claimed in claim 6, wherein the first direction is substantially a column direction, and wherein the second direction is substantially a row direction.

8. The touch screen panel as claimed in claim 5, wherein the first sensing patterns comprise X sensing patterns coupled to adjacent X sensing patterns in a column direction, and wherein the second sensing patterns comprise Y sensing patterns coupled to adjacent Y sensing patterns in a row direction.

9. The touch screen panel as claimed in claim 1, wherein the metal patterns are arranged corresponding to edge regions of the sensing patterns, and are arranged such that the sensing patterns are electrically coupled to corresponding ones of the position detecting lines in the first direction or the second direction.

10. The touch screen panel as claimed in claim 9, wherein the metal patterns are formed on the film prior to arranging the film on the sensing patterns.

11. The touch screen panel as claimed in claim 1, wherein the metal patterns and the position detecting lines electrically couple the sensing patterns to an external driving circuit.

12. The touch screen panel as claimed in claim 1, wherein the touch screen panel is configured to generate an electric signal including information of a contact position corresponding to a change in electrostatic capacitance at the contact position when a contact object contacts the second surface of the substrate at the contact position.

13. The touch screen panel as claimed in claim 1, wherein the sensing patterns are formed on the substrate by utilizing an exposing and developing process, and wherein the metal patterns and the position detecting lines are formed on the film before the film is attached to the touch screen panel.

14. The touch screen panel as claimed in claim 1, wherein the touch screen panel does not include an additional surface adapted to be contacted by a contact object.

15. The touch screen panel as claimed in claim 1, wherein the substrate comprises glass.
